(19) United States
(12) Patent Application Publication
(10) Pub. No.: US 2010/0121668 A1
(43) Pub. Date: May 13, 2010

(54) AUTOMATED COMPLIANCE CHECKING FOR PROCESS INSTANCE MIGRATION

(75) Inventor: Dennis Hohmann, Steinenbronn (DE)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 12/270,495

(22) Filed: Nov. 13, 2008

(51) Int. Cl. G06Q 10/00; G05B 13/02; G05B 19/02

(52) U.S. Cl. 705/8; 700/31; 700/89

(57) ABSTRACT

A business process workflow editorial data processing system can be provided. The system can include a workflow management system such as a BPEL process editing tool, and a repository of templates each template defining a process. At least two of the templates can include a new template and an existing template for an executing instance of a business process. The system also can include compliance checking logic coupled to the workflow management system. The logic can include program code enabled to derive a log of changes between the new template and the existing template based upon added and removed activities and links between activities in the executing process instance, to group the changes in the log according to common activities, to determine a wavefront for the executing process instance, and to migrate the executing process instance to the new template only if the wavefront does not cross any of the groups of the changes, but otherwise rejecting a migration of the process instance to the new template.

### REFERENCE TO CO-PENDING APPLICATIONS FOR PATENT

The present application is related to the following co-assigned U.S. patent application, which is expressly incorporated by reference herein:

U.S. application Ser. No. 12/024,718 entitled “MIGRATION OF PROCESS INSTANCES”, filed on Feb. 1, 2008.

### BACKGROUND OF THE INVENTION

1. Field of the Invention

The present invention relates to the field of business process instance migration and more particularly to compliance checking for business process instance migration.

2. Description of the Related Art

The achievement of universal interoperability between applications by using Web standards remains the principal goal of Web Services. Web Services use a loosely coupled integration model to allow flexible integration of heterogeneous systems in a variety of domains including business-to-consumer, business-to-business and enterprise application integration. The following basic specifications originally defined the Web Services space: the Simple Object Access Protocol (SOAP), the Web Services Description Language (WSDL), and Universal Description, Discovery, and Integration (UDDI). SOAP defines an XML messaging protocol for basic service interoperability. WSDL introduces a common grammar for describing services. UDDI provides the infrastructure required to publish and discover services in a systematic way. Together, these specifications allow applications to find each other and interact following a loosely coupled, platform-independent model.

Presently, the interaction model that is directly supported by WSDL essentially can be viewed as a stateless model of synchronous or uncorrelated asynchronous interactions. Models for business interactions typically assume sequences of peer-to-peer message exchanges, both synchronous and asynchronous, within stateful, long-running interactions involving two or more parties. Nevertheless, systems integration requires more than the mere ability to conduct simple interactions by using standard protocols. The full potential of Web Services as an integration platform will be achieved only when applications and business processes are able to integrate their complex interactions by using a standard process integration model.

The Business Process Execution Language (BPEL) for Web Services fulfills some aspects of a standard process integration model. The BPEL for Web Services specification defines a technology for integrating cross-enterprise business processes. By coordinating stateful interactions of loosely coupled services across enterprise boundaries, BPEL technology provides a means of modeling the interactions between an enterprise and its business partners, suppliers and customers and thus the value chain of the enterprise. More particularly, BPEL for Web Services defines a notation for specifying business process behavior based on Web Services.

Individually, a business process can be defined as a template written according to a process definition meta-language like BPEL. As such, each running instance of the business process can be derived from a corresponding defined template. Even still, occasionally it becomes necessary to change the defined template of a running instance of a business process. For example, improved versioning requires that a running instance of a business process be switched to another running instance of the business process defined according to a newer template.

Notwithstanding, switching a running instance of a business process to a new running instance during execution of a business process can be both expensive, and also error prone because of the requirement of manual compliance checks. Manual compliance checks are performed when changing the scheduling of activities in a process workflow in order to ensure the occurrence of predecessor activities prior to subsequent activities dependent upon the predecessor activities. When manual compliance checks lead to the conclusion that a running instance is not compliant, there are mainly two methods common for handling non-compliant instances.

In one manually performed method, a business analyst simply waits until the instance becomes compliant at some future time. To do so, however, requires that the analyst know how the process workflow engine executes internally. Yet, normally a business user modifying a business process does not possess this knowledge. Consequently, modifying the business process in the first instance requires human resources both demonstrating business and technical skills in order to determine an appropriate migration point—a costly proposition.

In a second method, a hybrid workflow can be generated and single instances can be migrated to the hybrid workflow. A hybrid workflow is a combination of the old and new template which is compliant to an instance and which contains as many of the desired changes as possible. A hybrid workflow also is specific for a class of instances. Thus, it can be challenging to determine the proposed change operations that can be applied to the workflow without losing compliance in the process instance. As in the first method, the determining which proposed change operations can be applied to the workflow must be performed manually and therefore can be expensive.

### BRIEF SUMMARY OF THE INVENTION

Embodiments of the present invention address deficiencies of the art in respect to compliance checking for process instance changes in a business process workflow and provide a novel and non-obvious method, system and computer program product for process instance compliance checking for process instance migration in a business process workflow. In an embodiment of the invention, a method for automated compliance checking for process instance migration can be provided.

The method can include comparing a new template and an existing template, both for an executing process instance, in order to determine added and removed activities and links between the activities to and from the process instance reflected in the new template. A log of changes can be derived between the templates based upon the added and removed activities and links between the activities and the changes in the log can be grouped according to common activities. A wavefront for the executing process instance can be determined—namely the current state of the executing process instance that can include contemporaneously executed activities, activities which have just completed, or activities that are scheduled to execute next, essentially a set of activities navigable in parallel. Thereafter, the process instance can be migrated to the new template only if the wavefront does not cross any of the groups of the changes. Otherwise a migration of the process instance to the new template can be rejected.

In another embodiment of the invention, a business process workflow editorial data processing system can be provided. The system can include a workflow management system such as a BPEL process editing tool, and a repository of templates each template defining a process. At least two of the templates can include a new template and an existing template for an executing instance of a business process. The system also can include compliance checking logic coupled to the workflow management system. The logic can include program code enabled to derive a log of changes between the new template and the existing template based upon added and removed activities and links between activities in the executing process instance, to group the changes in the log according to common activities, to determine a wavefront for the executing process instance, and to migrate the executing process instance to the new template only if the wavefront does not cross any of the groups of the changes, but otherwise rejecting a migration of the process instance to the new template.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated compliance checking for process instance migration;

FIG. 2 is a schematic illustration of a business process workflow editorial data processing system configured for automated compliance checking for process instance migration; and,

FIG. 3 is a flow chart illustrating a process for automated compliance checking for process instance migration.

### DETAILED DESCRIPTION OF THE INVENTION

Embodiments of the present invention provide a method, system and computer program product for automated compliance checking for process instance migration. In accordance with an embodiment of the present invention, a new template for a business process instance can be loaded for comparison with an existing template for the business process instance. Structurally dependent changes of both activities and links between activities can be logged and grouped according to the presence or absence of common activities in order to group interdependent activities implicated by the changes in the new template. Thereafter, the positioning of contemporaneously executed activities (the “wavefront”) can be determined relative to the interdependent activities and it can be determined whether the wavefront crosses a grouping of the interdependent activities. Specifically, the process instance for the new template will not be compliant if critical activities are scheduled to occur after the execution of the activities dependent upon the critical activities. If so, the instance stemming from the new template will be deemed compliant and not migrated. Otherwise, the instance stemming from the new template will be compliant and permitted to migrate.

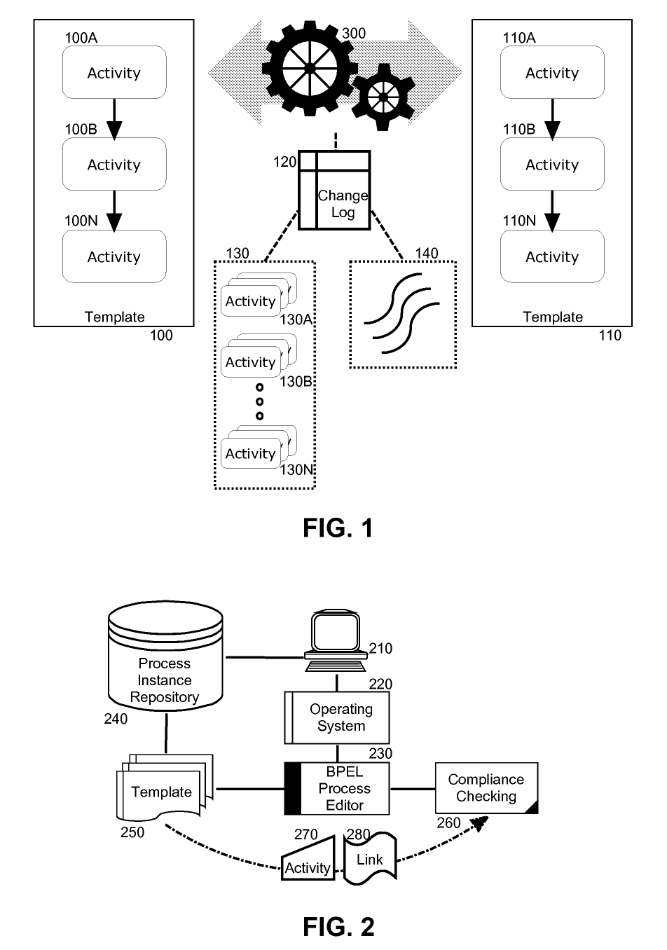

In further illustration, FIG. 1 pictorially depicts a process for automated compliance checking for process instance migration. As shown in FIG. 1, an existing template 100 for an instance of a process can define the ordered execution of different activities 100A, 100B, 100N. A new template 110 further can define the ordered execution of different activities 110A, 110B, 110N for the same process instance including one or more added or removed ones of the activities 100A, 100B, 100N, 110A, 110B, 110N. Automated compliance checking 300 can be performed on the new template 110 in order to ensure compliance of the order of execution of the activities 110A, 110B, 110N relative to a computed wavefront 140 for the process instance.

Specifically, a change log 120 of added or removed ones of the activities 100A, 100B, 100N, 110A, 110B, 110N and added or removed links between the activities 100A, 100B, 100N, 110A, 110B, 110N can be derived through a comparison of the activities 100A, 100B, 100N, 110A, 110B, 110N in the new and existing templates 100, 110. More specifically, the change log 120 can include a listing of added ones of the activities 100A, 100B, 100N, 110A, 110B, 110N, removed ones of the activities 100A, 100B, 100N, 110A, 110B, 110N, added links between activities 100A, 100B, 100N, 110A, 110B, 110N both new and existing, and removed links between removed and existing ones of the activities 100A, 100B, 100N, 110A, 110B, 110N.

Thereafter, the changes in the change log 120 can be placed in groupings 130 of groups 130A, 130B, 130N according to the presence or absence of common activities 110A, 110B, 110N implicated by the changes in order to group interdependent activities 110A, 110B, 110N implicated by the changes in the new template 110. Subsequently, a wavefront 140 for the process instance can be identified and compared to the groups 130A, 130B, 130N to detect whether or not the wavefront 140 crosses two of the groups 130A, 130B, 130N. If not, the process instance can be migrated. Otherwise, the process instance cannot be migrated. Notably, it will be recognized by the skilled artisan that the changes in the change log 120 need be based only upon information in the templates 100, 110. Consequently, determining the changes in the change log 120 need be performed only once and the information can be reused for compliance checking of all instances of the process to be migrated.

The process described in connection with FIG. 1 can be implemented within a business process workflow editorial data processing system. In more particular illustration, FIG. 2 is a schematic illustration of a business process workflow editorial data processing system configured for automated compliance checking for process instance migration. The system can include a host computing platform 210 executing an operating system 220. The operating system 220 in turn can support the operation of a workflow management system 230, for example a BPEL process editing tool storing defined processes and executing process instances in a process instance repository 240. In particular, the repository 240 can store different templates 250 each defining activities 270 and links 280 between activities 270 for a process instance.

Notably, compliance checking logic 260 can be coupled to the workflow management system 230. The compliance checking logic 260 can include program code enabled to compare an existing one of the templates 250 to a new one of the templates 250 for an executing process instance in order to log changes in the process instance with respect to the activities 270 and links 280 defined therein. The program code further can be enabled to group the changes in the log into change groups in accordance with common ones of the activities 270. The program code yet further can be enabled to determine a wavefront for the executing process instance and to detect whether or not the wavefront crosses any of the change groups. Finally, the program code can be enabled to permit migration only if the wavefront does not cross any of the change groups.

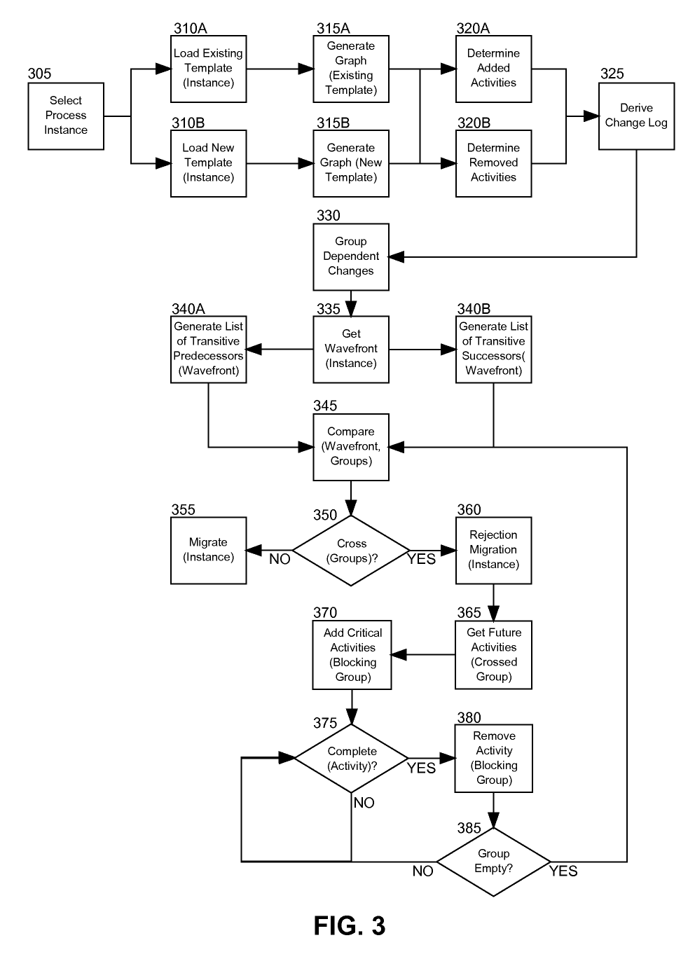

In yet further illustration of the operation of the compliance checking logic 260, FIG. 3 is a flow chart illustrating a process for automated compliance checking for process instance migration. Beginning in block 305, an executing process instance can be selected for migration from an existing template to a new template. As such, in blocks 310A, 310B, both the existing template and new template for the selected process instance can be loaded. Likewise, in blocks 315A, 315B, graphs can be generated for each of the templates as is well-known in the art. In block 320A, added activities to the selected process instance and corresponding requisite links can be determined by comparing the activities of the new template to the intersection of the activities of the new and old templates.

Similarly, in block 320B, the removed activities and corresponding requisite links from the selected process instance can be determined by comparing the activities of the old template with the intersection of the activities of the new and old templates. It is to be understood, there are different methodologies useful in determining the intersection of activities of the new and old templates. For example, during modeling unique identifiers can be assigned to activities, or a string representation of each description of an activity in a corresponding BPEL file can be compared in order to determine which activities are new and which activities are to be removed.

In block 325, a change log can be derived to indicate the changes to be imparted to the selected process instance in terms of adding and removing activities and links between the activities. In block 330, the changes in the change log can be grouped according to changes sharing the same activity. Specifically, all change operations which have at least one involved activity in common can be placed in one group. If an involved activity of a change operation in a group is not disjunct with another involved activity of a remaining change operation, the change operation is added to the group. Conversely, the remaining change operations are each placed individually in separate groups.

Thereafter, in block 335 a wavefront for the executing process instance can be determined as the contemporaneously executing process instance. In block 340A, a list of transitive predecessor (past) activities to the wavefront can be generated as can a list of transitive successor activities (future) to the wavefront in block 340B. In block 345, the wavefront can be compared to the groups according to the lists of transitive predecessor and successor activities.

In decision block 350, if it is determined that the wavefront does not cross one of the groups, e.g. that the activities of a group cannot be found in both the generated lists of transitive predecessor activities and successor activities, then in block 355 the process instance will be deemed compliant and the process instance will be permitted to migrate to the new template. However, if it is determined that the wavefront does cross one of the groups in decision block 350, then in block 360 the migration can be rejected for non-compliance. Yet, the migration can be permitted to cure subsequently through a monitoring of the movement of the wavefront during the execution of the process instance.

Specifically, in block 365, the successor activities for the crossed group can be retrieved and added to a new “blocking” group in block 370. In decision block 375 it can be determined whether or not an activity in the blocking group has completed in the executing process instance. If so, in block 380 the activity can be removed from the blocking group and in decision block 385 it can be determined whether or not the blocking group contains no more activities. If the blocking group is empty, the process can return to block 345 to compare the wavefront to the change groups in an attempt once again to migrate the process instance.

Notably, in an aspect of the embodiment described herein, changes across multiple different templates to the same process instance can be accommodated in consideration of the reality that oftentimes, multiple individuals apply template changes to the same process instance over time and prior to migrating a process instance to a new version merging the template changes. In particular, an intermediate change log can be created for each pair of successive templates for the process instance such that multiple different intermediate change logs can describe changes between different intermediate versions of the process instance reflected by corresponding templates. The intermediate change logs can be analyzed and merged to determine the change log between the existing version reflected by the existing template and the most recent version reflected by the most recent template.

For example, the change log incorporating the merged changes of the intermediate change logs can be computed by looping through each successive intermediate change log. For each change of each group in an intermediate change log and the merged change log, at least one common activity with the change in the intermediate change log and the merged change log can be identified. Thereafter, the identified change can be added to the corresponding group in the merged change log. The remaining changes in the intermediate change log not sharing a common activity with changes in the merged change log, a new group can be added to the merged change log to include the remaining changes. Thus, the resulting merged change log will reflect changes between the existing template and the most recent template and can be used for compliance checking. Further, in compliance checking, the process instance can be safely migrated if the wavefront of the process instance does not cross any of the groups in the merged change log.

In another aspect of the embodiment, the computation of the merged change log can be performed even in the absence of all intermediate change logs. Rather, the BPEL files for different templates can be processed to compute the merged change log. More particularly, all activities of the BPEL file are marked with an identifier such that identical changes of both processes can be associated with the same identifier. The unique identifier can be generated, for example, from a string representation of the activity in the BPEL file. Likewise, a unique identifier can be generated for every link in the BPEL file and combined with linked activities as a tuple of the link identifier, source activity identifier and target activity identifier.

Subsequently, structured activities in a flow can be uniquely identified. Each flow identifier can include a tuple containing a string representation of the flow activity with the identifiers of the contained activities and links therein removed, along with string representations of the contained activities and links. Consequently, it is assured that different flows with the same business process logic receive the same identifier although the respective string representations in the BPEL process may differ. Further, the unique identification of a flow can allow for ease of determination when the business logic within the flow has been changed or whether the flow itself has changed merely by inspecting the combination of identifiers of the links and activities in the flow identifier.

Finally, each sequence of flows can be uniquely identified. As in the case of uniquely identifying a flow, a sequence can be uniquely identified with a tuple containing a string representation of the sequence with the identifiers of the contained flows, along with string representations of the activities and links of the removed flows. In this way, the unique identifiers of the activities and links, flows and sequences permit a comparison of different BPEL files to compute the merged change log for different templates of an existing process instance.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be appreciated that various changes may be made to the described embodiments without departing from the principles and spirit of the invention, the scope of which is defined by the appended claims.

I claim:

1. A method for automated compliance checking for process instance migration, the method comprising:
comparing a new template and an existing template, both for an executing process instance, in order to determine added and removed activities and links between the activities to and from the process instance reflected in the new template;
deriving a log of changes between the templates based upon the added and removed activities and links between the activities;
grouping the changes in the log according to common activities;
determining a wavefront for the executing process instance; and,
migrating the process instance to the new template only if the wavefront does not cross any change group of the changes, but otherwise rejecting a migration of the process instance to the new template.

2. The method of claim 1, wherein deriving a log of changes between the templates based upon the added and removed activities and links between the activities, comprises:
computing added activities to the process instance by comparing activities reflected by the new template to an intersection of activities reflected by both the new and existing template;
further computing removed activities from the process instance by comparing activities reflected by the existing template to an intersection of activities reflected by both the new and existing template; and,
logging changes requisite to adding and removing respectively the computed added activities and new activities and links therebetween.

3. The method of claim 1, wherein migrating the process instance to the new template only if the wavefront does not cross any change group of the changes, but otherwise rejecting a migration of the process instance to the new template, comprises:
generating a first list of transitive predecessor activities for the wavefront;
generating a second list of transitive successor activities for the wavefront;
comparing each group to the activities in the first and second lists; and,
migrating the process instance only if the activities in each group do not span both the first and second lists.

4. The method of claim 3, further comprising:
adding the activities from the second list to a blocking group when it is determined that activities in a group span both the first and second lists;
upon completion of each activity in the blocking group removing the completed activity from the blocking group; and,
responsive to determining no further activities remaining in the blocking group, re-performing the determining and migrating steps.

5. A business process workflow editorial data processing system comprising:
a workflow management system;
a repository of templates each template defining a process, at least two of the templates comprising a new template and an existing template for an executing instance of a business process; and,
compliance checking logic coupled to the workflow management system, the logic comprising program code enabled to derive a log of changes between the new template and the existing template based upon added and removed activities and links between activities in the executing process instance, to group the changes in the log according to common activities, to determine a wavefront for the executing process instance, and to migrate the executing process instance to the new template only if the wavefront does not cross any of the change groups, but otherwise rejecting a migration of the process instance to the new template.

6. The system of claim 5, wherein the workflow management system is a business process execution language (BPEL) process editing tool.

7. A computer program product comprising a computer usable medium embodying computer usable program code for automated compliance checking for process instance migration, the computer program product comprising:
computer usable program code for comparing a new template and an existing template, both for an executing process instance, in order to determine added and removed activities and links between the activities to and from the process instance reflected in the new template;
computer usable program code for deriving a log of changes between the templates based upon the added and removed activities and links between the activities;
computer usable program code for grouping the changes in the log according to common activities;
computer usable program code for determining a wavefront for the executing process instance; and,
computer usable program code for migrating the process instance to the new template only if the wavefront does not cross any change group, but otherwise rejecting a migration of the process instance to the new template.

8. The computer program product of claim 7, wherein the computer usable program code for deriving a log of changes between the templates based upon the added and removed activities and links between the activities, comprises:
computer usable program code for computing added activities to the process instance by comparing activities reflected by the new template to an intersection of activities reflected by both the new and existing template;
computer usable program code for further computing removed activities from the process instance by comparing activities reflected by the existing template to an intersection of activities reflected by both the new and existing template; and,
computer usable program code for logging changes requisite to adding and removing respectively the computed added activities and new activities and links therebetween.

9. The computer program product of claim 7, wherein the computer usable program code for migrating the process instance to the new template only if the wavefront does not cross any change group of the changes, but otherwise rejecting a migration of the process instance to the new template, comprises:
computer usable program code for generating a first list of transitive predecessor activities for the wavefront;
computer usable program code for generating a second list of transitive successor activities for the wavefront;
computer usable program code for comparing each group to the activities in the first and second lists; and,
computer usable program code for migrating the process instance only if the activities in each group do not span both the first and second lists.

10. The computer program product of claim 9, further comprising:
computer usable program code for adding the activities from the second list to a blocking group when it is determined that activities in a group span both the first and second lists;
computer usable program code for upon completion of each activity in the blocking group removing the completed activity from the blocking group; and,
computer usable program code for responsive to determining no further activities remaining in the blocking group, re-performing the determining and migrating steps.

11. A method for automated compliance checking for process instance migration, the method comprising:
loading a new template for an executing process instance, an existing template for the executing process instance, and a succession of intermediate templates for the executing process instance created temporally successively between the new template and the existing template;
comparing each template with a successor template in order to determine added and removed activities and links between the activities to and from the process instance reflected between the compared templates;
deriving a log of changes for each compared template and successor template based upon the added and removed activities and links between the activities;
grouping the changes in the log of changes according to common activities;
merging each derived log of changes into a merged log of changes;
determining a wavefront for the executing process instance; and,
migrating the process instance to the new template only if the wavefront does not cross any of the groups of the changes in the merged log of changes, but otherwise rejecting a migration of the process instance to the new template.
